(19) United States
(12) Patent Application Publication
(10) Pub. No.: US 2026/0368009 A1
(43) Pub. Date: Nov. 19, 2026

(54) API CALL CONTROL METHOD AND APPARATUS THEREFOR

(71) Applicant: HYUNDAI AUTOEVER CORP., Seoul (KR)

(72) Inventor: Ji Hoon JUNG, Seoul (KR)

(21) Appl. No.: 19/671,880

(22) Filed: May 8, 2026

(30) Foreign Application Priority Data
May 13, 2025 (KR) 10-2025-0061679

(51) Int. Cl. G06F 9/54; G06F 21/62

(52) U.S. Cl. CPC G06F 9/547; G06F 21/629

(57) ABSTRACT

Methods and devices for controlling an application programming interface (API) call are described. According to one embodiment, a method includes: detecting a call to a protected API, determining, using a flag indicating an authority state, whether the call has been made by an authorized component to which a call authority has been granted, and in response to determining the call to have been made by an unauthorized component to which call authority has not been granted, disallowing execution of the protected API, wherein the flag is configured to be set only by an authority component to which an authority of setting the flag has been granted.

### CROSS-REFERENCE TO RELATED APPLICATION

This application claims priority from Korean Patent Application No. 10-2025-0061679 filed on May 13, 2025, in the Korean Intellectual Property Office, and all the benefits accruing therefrom under 35 U.S.C. 119, the contents of which in its entirety are herein incorporated by reference.

### BACKGROUND

### 1. Field

The present disclosure relates to an application programming interface (API) call control method and an apparatus therefor, and more particularly, to an API call control method and an apparatus therefor for preventing an unauthorized call to a protected API by a component to which call authority has not been granted.

### 2. Description of the Related Art

Conventional vehicles are composed of assemblies of mechanical devices. However, in recent years, as advanced functions such as vehicle posture control, automatic parking, intelligent driving assistance, and autonomous driving have become widespread, various electronic control units have been integrated into vehicles, and interworking among such electronic devices has emerged as a core element of a vehicle system.

As the number of electronic devices in a vehicle has increased, the complexity of software executed in each electronic device has also increased. Accordingly, a need for structural standardization of software has arisen. In response to this need, an embedded software open platform referred to as AUTomotive Open System Architecture (AUTOSAR) has been proposed for the purpose of ensuring reusability of modules and compatibility of components among vehicles, and is widely adopted as a de facto standard for vehicle software.

AUTOSAR defines, based on a hierarchical software architecture, a run-time environment (RTE) as an interface between an application layer and a basic software (BSW) layer, and the application layer is structured to access functions of a lower layer only through the RTE.

However, in an actual development environment, a problem arises in that such structural constraints are not always observed. For example, there are cases in which the application layer bypasses the RTE and directly accesses internal functions or resources of the BSW, which may unintentionally change a state of the BSW or cause an exceptional execution flow, thereby threatening system stability.

As a method for addressing such a problem, a scheme of controlling access of the application layer by setting priorities among tasks may be considered. However, in an AUTOSAR environment, since a developer may set a priority of an application task higher than that of a BSW task, such a scheme alone has a limitation in effectively blocking abnormal calls.

Accordingly, there is a need for a protection scheme capable of effectively blocking illegal API calls.

### SUMMARY

An objective of the present disclosure is to provide a method and apparatus for verifying legality of a call before execution of an application programming interface (API) and blocking, in advance, an API call by a component to which authority has not been granted.

Another objective of the present disclosure is to provide a method and apparatus for efficiently determining legality of a call based on a flag indicating an authority state and controlling execution of an API through the determination.

Yet another objective of the present disclosure is to provide a method and apparatus for preventing illegal execution of an API by a component to which authority has not been granted even in a preemption situation.

Still another objective of the present disclosure is to provide a method and apparatus for supporting detection of an illegal API call and identification and correction of a cause of the illegal API call when the illegal API call occurs in a development stage.

The objectives of the present disclosure are not limited to those mentioned above, and other objectives not explicitly stated will be clearly understood by those skilled in the art based on the following description.

According to an aspect of the present disclosure, there is provided an application programming interface (API) call control method performed by a computing device. The method may comprise detecting a call to a protected API, determining, using a flag indicating an authority state, whether the call has been made by an authorized component to which a call authority has been granted, and in response to determining the call to have been made by an unauthorized component to which the call authority has not been granted, disallowing execution of the protected API, wherein the flag is configured to be set only by an authority component to which a flag-setting authority has been granted.

In some aspects, the component to which call authority has been granted is configured to call the protected API through a component to which flag-setting authority has been granted.

In some aspects, determining whether the call has been made by the component to which call authority has been granted may include determining a state of the flag; and in response to determining that the flag is set to an activated state, determining that the call has been made by the component to which call authority has been granted, and in response to determining that the flag is set to a deactivated state, determining that the call has been made by a component to which call authority has not been granted.

In some aspects, determining whether the call has been made by the component to which call authority has been granted further may include in response to determining that the flag is set to the activated state, determining validity of the flag; and in response to determining the flag to be valid, determining that the call has been made by the component to which call authority has been granted, and in response to determining the flag to be invalid, determining that the call has been made by a component to which call authority has not been granted.

In some aspects, determining validity of the flag may include identifying an address of a component that has requested setting of the flag; and determining, by using the address, whether the component that has requested setting of the flag is a component to which flag-setting authority has been granted.

In some aspects, disallowing execution of the protected API may include processing the call as an error.

In some aspects, processing the call as an error may include generating an alert signal indicating that the call has been made by a component to which call authority has not been granted.

In some aspects, the method may further include in response to determining the call to have been made by the component to which call authority has been granted, allowing execution of the protected API, wherein allowing execution of the protected API comprises: executing code of the protected API; and in response to execution of the code being completed, setting the flag to the deactivated state.

According to another aspect of the present disclosure, there is provided an application programming interface (API) call control method performed by a computing device. The method may comprise executing, by a first instance executed by the computing device, code of a protected API while a flag indicating an authority state is in an activated state, in response to preemption of a processor being caused by a second instance while the code is being executed, setting the flag to a deactivated state, and after the preemption, when execution of the code resumes, setting, by the first instance, the flag to the activated state.

In some aspects, the method may further include resuming execution of the code of the protected API by the first instance, and in response to execution of the code being completed, setting the flag to a deactivated state.

In some aspects, the method may further include before executing the code of the protected API, detecting a call to the protected API, and determining, using the flag, whether the call has been made by a component to which call authority has been granted.

In some aspects, determining whether the call has been made by the component to which call authority has been granted may include determining a state of the flag; and in response to determining that the flag is set to the activated state, determining that the call has been made by the component to which call authority has been granted, and in response to determining that the flag is set to the deactivated state, determining that the call has been made by a component to which call authority has not been granted.

In some aspects, determining that the call has been made by the component to which call authority has been granted may include in response to determining that the flag is set to the activated state, determining validity of the flag; and in response to determining the flag to be valid, determining that the call has been made by the component to which call authority has been granted, and in response to determining the flag to be invalid, determining that the call has been made by a component to which call authority has not been granted.

In some aspects, determining validity of the flag may include identifying an address of a component that has requested setting of the flag; and determining, by using the address, whether the component is a component to which flag-setting authority has been granted.

According to yet another aspect of the present disclosure, there is provided a computing device. The computing device may comprise at least one processor, a communication interface, a memory configured to load a computer program executed by the at least one processor, and a storage configured to store the computer program, wherein: the computer program includes instructions for performing operations of: detecting a call to a protected application programming interface (API), determining, using a flag indicating an authority state, whether the call has been made by an authorized component to which a call authority has been granted; and in response to determining the call to have been made by an unauthorized component to which the call authority has not been granted, disallowing execution of the protected API, and the flag is configured to be set only by an authority component to which flag-setting authority has been granted.

In some aspects, the operation of determining whether the call has been made by a component to which call authority has been granted may include determining a state of the flag; and in response to determining that the flag is set to an activated state, determining that the call has been made by the component to which call authority has been granted, and in response to determining that the flag is set to a deactivated state, determining that the call has been made by a component to which call authority has not been granted.

In some aspects, the operation of determining whether the call has been made by a component to which call authority has been granted further may include in response to determining that the flag is set to the activated state, determining validity of the flag, and in response to determining the flag to be valid, determining that the call has been made by the component to which call authority has been granted, and in response to determining the flag to be invalid, determining that the call has been made by a component to which call authority has not been granted.

In some aspects, determining validity of the flag may include identifying an address of a component that has requested setting of the flag, and determining, by using the address, whether the component that has requested setting of the flag is a component to which flag-setting authority has been granted.

In some aspects, the operation of disallowing execution of the protected API comprises processing the call as an error.

In some aspects, the computer program further may include instructions for performing an operation of allowing execution of the protected API in response to determining the call to have been made by the component to which call authority has been granted, and the operation of allowing execution of the protected API comprises: executing code of the protected API; and in response to execution of the code being completed, setting the flag to the deactivated state.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a configuration diagram for explaining an AUTomotive Open System Architecture (AUTOSAR) platform that may be referenced in some embodiments of the present disclosure;

FIG. 2 is a flowchart illustrating an activation and application procedure of a protection mechanism according to an embodiment of the present disclosure;

FIG. 3 is a flowchart illustrating an application programming interface (API) call control method according to an embodiment of the present disclosure;

FIG. 4 illustrates detailed operations of step S32 of FIG. 3;

FIG. 5 illustrates detailed operations of step S44 of FIG. 4;

FIG. 6 illustrates detailed operations of step S33 of FIG. 3;

FIG. 7 is a flowchart illustrating an API call control method according to another embodiment of the present disclosure;

FIG. 8 illustrates an operation subsequent to that of FIG. 7; and

FIG. 9 is a hardware configuration diagram of a computing device according to some embodiments of the present disclosure.

### DETAILED DESCRIPTION

Hereinafter, preferred embodiments of the present disclosure will be described in detail with reference to the accompanying drawings. The advantages and features of the present disclosure, and methods for achieving the same, will become apparent with reference to the embodiments described below in detail in conjunction with the accompanying drawings. However, the technical idea of the present disclosure is not limited to the embodiments described below and may be implemented in various different forms. The embodiments are provided only to fully disclose the technical idea of the present disclosure and to enable those skilled in the art to fully understand the scope of the present disclosure. The scope of the present disclosure is defined only by the claims.

In assigning reference numerals to the components of the drawings, it should be noted that like reference numerals are used for like elements throughout the drawings as much as possible, even if the elements are illustrated in different drawings. In addition, when describing the present disclosure, detailed descriptions of related well-known configurations or functions may be omitted if it is determined that such descriptions would unnecessarily obscure the gist of the present disclosure.

Unless otherwise defined, all terms (including technical and scientific terms) used herein have the same meanings as commonly understood by those skilled in the art to which the present disclosure pertains. In addition, terms defined in commonly used dictionaries should not be interpreted in an idealized or overly formal sense unless expressly so defined herein. The terminology used herein is for the purpose of describing particular embodiments only and is not intended to limit the present disclosure. As used herein, the singular forms are intended to include the plural forms as well, unless the context clearly indicates otherwise.

In addition, in describing the components of the present disclosure, terms such as first, second, A, B, (a), and (b) may be used. These terms are used only to distinguish one component from another component and do not limit the nature, order, or sequence of the corresponding components. When a component is described as being “connected,” “coupled,” or “linked” to another component, it should be understood that the component may be directly connected, coupled, or linked to the other component, or that intervening components may be present between the components.

Further, the terms “comprise(s)” and/or “comprising” when used herein specify the presence of stated features, integers, steps, operations, elements, and/or components, but do not preclude the presence or addition of one or more other features, integers, steps, operations, elements, components, and/or groups thereof.

Hereinafter, several embodiments of the present disclosure will be described in detail with reference to the accompanying drawings.

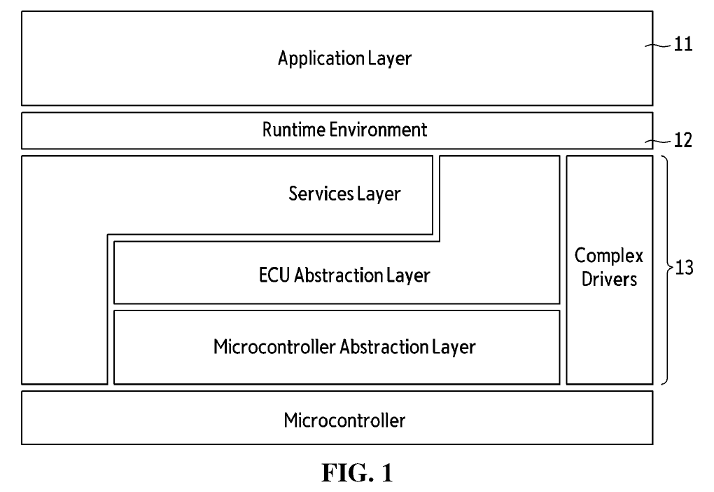

FIG. 1 is a configuration diagram for describing an AUTomotive Open System Architecture (AUTOSAR) platform that may be referenced in some embodiments of the present disclosure.

Referring to FIG. 1, AUTOSAR-based vehicle software includes an application layer 11, a run-time environment (RTE) 12, and basic software (BSW) 13.

The application layer 11 includes software components (SWCs). The SWCs include application software that performs major functions of a vehicle such as engine control, automatic transmission control, and brake control. The SWCs are arranged in a virtual network environment and interwork with electronic control units (ECUs), and have an independent structure that is not dependent on hardware. The SWCs may be classified, according to functions thereof, into applications, sensors, actuators, and the like.

The RTE 12 is positioned between the application layer 11 and the BSW 13 and enables data exchange between modules by providing a standardized interface for communication therebetween. Specifically, the RTE 12 mediates communication between the SWCs or between the SWCs and the BSW 13 and supports independent operation of the SWCs without dependence on specific hardware.

The BSW 13 is positioned at a lowest layer and provides basic services required for operation of the SWCs, such as an operating system (OS), device drivers, and communication stacks. The BSW 13 includes a service layer, an ECU abstraction layer, a microcontroller abstraction layer (MCAL), and a complex drivers(CDD) layer.

The service layer provides services such as memory management, communication network control, and system functions. The ECU abstraction layer supports access from an upper layer to lower devices through a hardware-specific transceiver or interface driver. The MCAL layer, which is an area having high hardware dependency, includes a communication driver (e.g., an OSI data link layer driver), an analog and digital I/O driver such as an ADC, PWM, or DIO driver, a memory driver such as an EEPROM or flash driver, and other peripheral drivers of a microcontroller. The complex drivers layer is used to implement special functions that are not defined in the AUTOSAR standard.

As described above, the BSW 13 performs a mediator role between the SWCs and hardware through a layered structure including an OS, drivers, and middleware, and each function is configured in a module unit and is provided to the SWCs in the form of an application programming interface (API) through the RTE. In particular, according to the AUTOSAR standard, an SWC must use only APIs provided through the RTE 12, and direct access to internal functions or modules of the BSW 13 is prohibited. This is to maintain clear role separation between layers and to ensure system stability.

However, in an actual development environment, there are cases in which such structural constraints are not observed. For example, an SWC may bypass the RTE 12 and directly call an internal function or module of the BSW 13. In this case, hierarchical independence and modularization principles of the AUTOSAR architecture may be compromised, and the possibility of unexpected changes in an internal state of the BSW 13 or occurrence of software defects may increase.

Accordingly, in the present disclosure, the BSW 13, and specifically an internal API of the BSW 13, may include a protection mechanism for preventing improper direct calls from an SWC. Such a protection mechanism may be used, for example, to detect and block improper API calls during a software development stage.

Specifically, in a development stage, the protection mechanism may be configured to be activated, thereby effectively preventing abnormal access to the internal API of the BSW 13 due to developer mistakes or unexpected changes in an internal state of the BSW 13. In a release stage, the protection mechanism may be configured to be deactivated in order to minimize processor load and improve response time. However, the present disclosure is not limited thereto, and in the release stage, in order to enhance system stability or security, the protection mechanism may be maintained, or some functions thereof may be included.

Hereinafter, a specific method for implementing a structure in which the protection mechanism is activated in the development stage and deactivated in the release stage will be described.

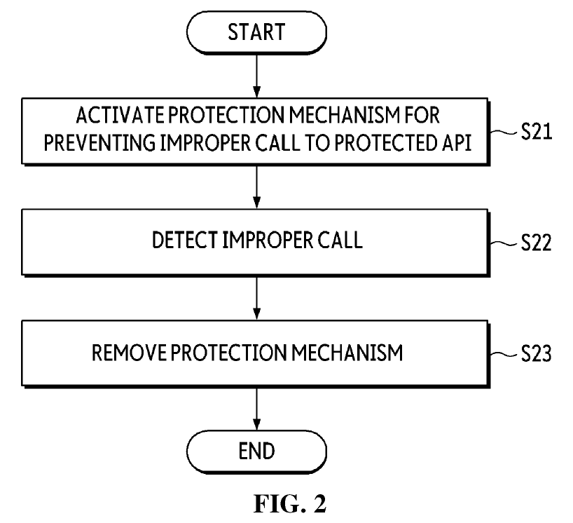

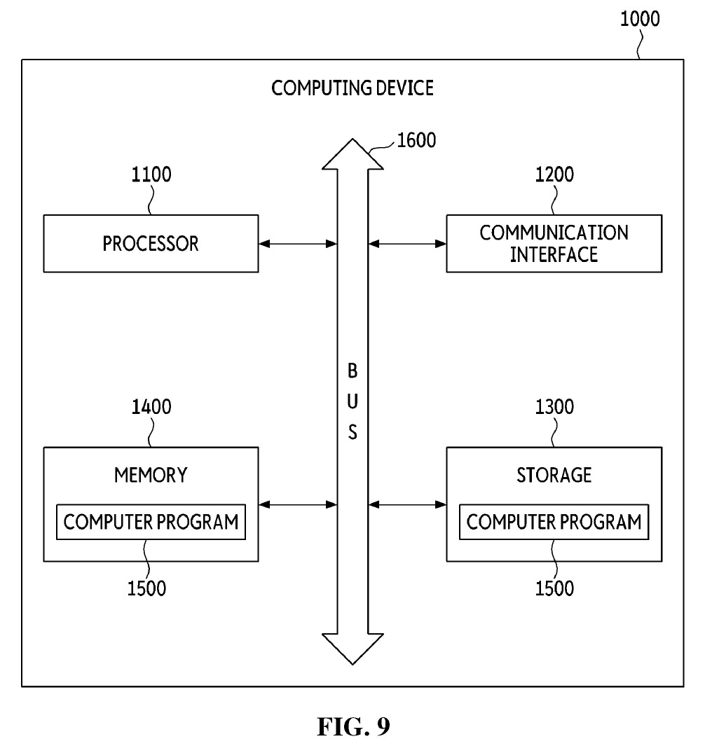

FIG. 2 is a flowchart illustrating an activation and application procedure of a protection mechanism according to an embodiment of the present disclosure. A method of this embodiment may be executed by a computing device illustrated in FIG. 9. Description of a subject performing some operations included in the method of this embodiment may be omitted, in which case, it should be understood that the subject is the computing device.

Referring to FIG. 2, first, in step S21, a protection mechanism for preventing an improper call to a protected API may be activated. Here, an improper call refers to a case in which a component that has not been granted call authority directly calls the protected API. Hereinafter, a call performed by a component to which call authority has not been granted may, depending on circumstances, be referred to as an improper call, an illegal call, an unauthorized call, or an abnormal call. In addition, a call performed by a component to which call authority has been granted may, depending on circumstances, be referred to as a legal call, an authorized call, or a normal call.

Specifically, when a component that does not belong to the same layer as the protected API and is positioned at an upper layer directly calls the protected API, this may be an illegal call by a component that has not been granted call authority. For example, when the protected API is an internal API included in a BSW layer, a direct call to the internal API by a component of an upper layer such as an SWC may correspond to an illegal call.

On the other hand, a call between components positioned in the same layer, or a call performed through a call path permitted by system specifications or policies, may be a legal call. For example, when an SWC calls a service API provided through an RTE and the service API calls an API of the BSW layer, or when a call is performed between different components included in the BSW layer, such a call may correspond to a legal call.

In an embodiment, the protection mechanism may be activated in a pre-compilation stage. Specifically, by declaring a particular conditional compilation directive, protection logic may be inserted before and after execution of the protected API. Here, the protection logic may include logic (hereinafter referred to as the legality determination logic) inserted at a beginning of an API call to determine whether the API call is a legal call and logic (hereinafter referred to as the initialization logic) inserted at a time point when execution of the protected API ends to initialize an authority state.

Specifically, when the protection mechanism is activated, the legality determination logic may be inserted at a beginning of code of the protected API. The legality determination logic may determine whether the API call is a legal call by using a flag indicating an authority state and may be configured to prevent execution of the protected API when the API call is an illegal call and to allow execution of the protected API when the API call is a legal call. Here, the flag indicating the authority state is used as a reference indicator for determining whether the API call is a call by a component having call authority. The flag may be managed as a shared resource and may be stored and managed, for example, in a memory region commonly accessible to a plurality of modules or tasks in a system. In addition, the flag may be set only by a component that has been granted flag-setting authority.

In addition, the initialization logic may be inserted at an end point of the code of the protected API. The initialization logic may initialize the authority state after execution of the protected API by setting the flag to a deactivated state after completion of the API call.

The legality determination logic and the initialization logic may be integrally implemented as a single protection function (e.g., protect()) and may be called in a wrapper manner that surrounds the protected API, such that the legality determination logic is executed before execution of the protected API and the initialization logic is executed after completion of the execution, thereby collectively processing an entire protection flow.

When a call is performed by a component that has been granted authority, the flag indicating the authority state should be in an activated state at a time point of the call. For example, since a call between internal modules in the BSW layer is a legal call, when a module or component belonging to the BSW layer calls the protected API within the same layer, the flag may be configured to be activated at a time point of the call.

For this purpose, according to structural or policy criteria, a call defined as a legal call may be configured to be performed through a predefined trusted protection path, for example through a component to which flag-setting authority has been granted. When the protected API is called through such a trusted protection path, logic for automatically setting the flag indicating the authority state to an activated state before execution of the protected API may be performed. In this case, the trusted protection path may be configured such that access by a component that has not been granted call authority is impossible. For example, when a call between modules in the BSW layer is configured to be performed through the trusted protection path, the trusted protection path may be configured such that access from an SWC is restricted.

In step S22, in a state in which the protection mechanism is activated, an improper call to the protected API may be detected during runtime. Specifically, when a call to the protected API is detected, legality of the call may be determined by the protection logic, and when the call is determined to be illegal, the call may be processed as an error, and an alert signal corresponding thereto may be generated. The alert signal may be output in the form of, for example, a debugging log or a system event, and through this, a developer may identify a time point at which the improper call has occurred and a code location of the improper call. Accordingly, the developer may analyze and modify source code of the improper call, thereby correcting a call flow of the system to a legal path.

Subsequently, in step S23, the protection mechanism is removed. Specifically, when code modification for the improper call is completed and the system transitions to a release stage, a conditional compilation directive declared in the development stage may be deleted or invalidated such that the protection mechanism is excluded from a final compilation target.

Thus far, with reference to FIG. 1, a configuration of the AUTOSAR platform that may be referenced in some embodiments of the present disclosure has been described, and with reference to FIG. 2 detailed operations for applying the protection mechanism has been described. The embodiments described above may be more specifically and clearly understood by referring to other embodiments to be described below. In addition, technical concepts that may be understood through the embodiments described above may be equally applied or reflected in other embodiments to be described below even when not explicitly described.

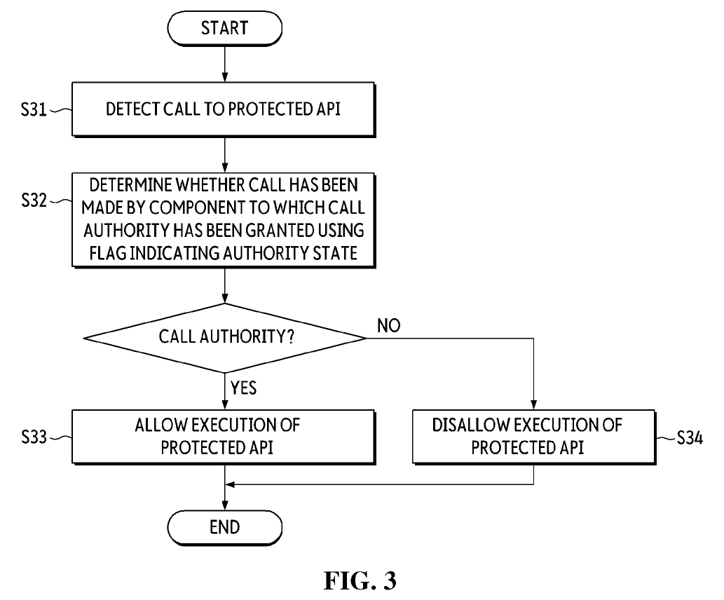

Hereinafter, with reference to FIGS. 3 and the subsequent drawings, specific operations for controlling an API call based on the protection mechanism according to an embodiment of the present disclosure will be described in detail.

FIG. 3 is a flowchart illustrating an API call control method according to an embodiment of the present disclosure. However, this is merely a preferred embodiment for achieving the objectives of the present disclosure, and some steps may be added or omitted as necessary. In addition, an operating subject of each step may be a computing device, but for convenience of description, a description thereof may be omitted.

First, in step S31, a call to a protected API may be detected. The protected API is an API intended to be protected from a direct call by a component to which call authority has not been granted and may be, for example, an internal API included in a BSW layer. As described above, the protected API includes legality determination logic for determining whether a caller has authority before execution of the protected API, and detection of the call to the protected API may mean that the legality determination logic inserted at a beginning of code of the protected API is executed in response to the call to the protected API.

At this time, when the protected API is called through a component to which flag-setting authority has been granted, a flag indicating an authority state may be in an activated state. Specifically, a component to which call authority has been granted may be configured to call the protected API through a component to which flag-setting authority has been granted. When the protected API is called through such a configured call path, logic for setting the flag to the activated state before execution of the protected API may be automatically performed, such that the flag is set to the activated state at a time point of the call.

On the other hand, when the protected API is directly called by a component to which call authority has not been granted, the flag may be in a deactivated state at a time point of the call. Such a flag may serve as a reference indicator for determining, in a subsequent step, whether the call is a legal call performed by a component to which call authority has been granted.

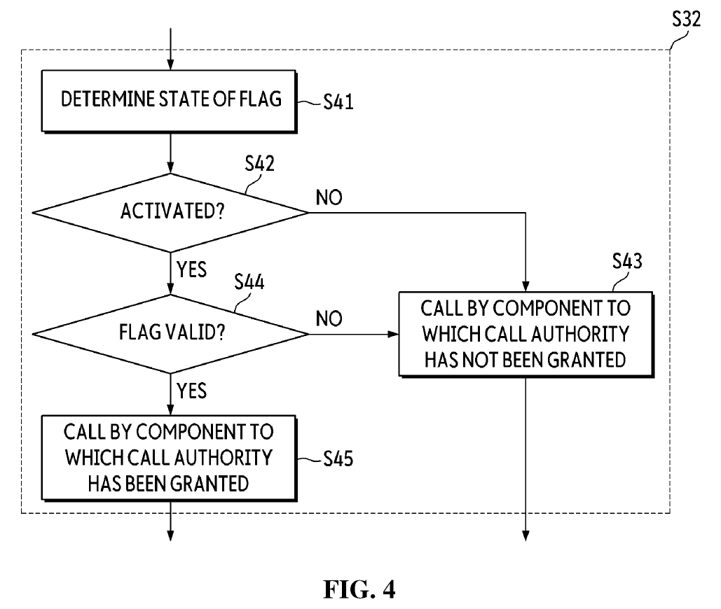

Subsequently, in step S32, by using the flag indicating the authority state, a determination may be made as to whether the call has been made by a component to which call authority has been granted. This will hereinafter be described in detail with reference to FIG. 4.

FIG. 4 illustrates detailed operations of step S32 of FIG. 3.

Referring to FIG. 4, first, in step S41, a state of the flag indicating the authority state may be determined. As described above, the flag may be managed as a shared resource, and when a call is detected, the state of the flag (an activated state or a deactivated state) may be determined.

Subsequently, a determination may be made as to whether the flag is in the activated state (S42). When the flag is set to the activated state (YES), the call may be determined to have been made by a component to which call authority has been granted. On the other hand, when the flag is set to the deactivated state (NO), the call may be determined to have been made by a component to which call authority has not been granted.

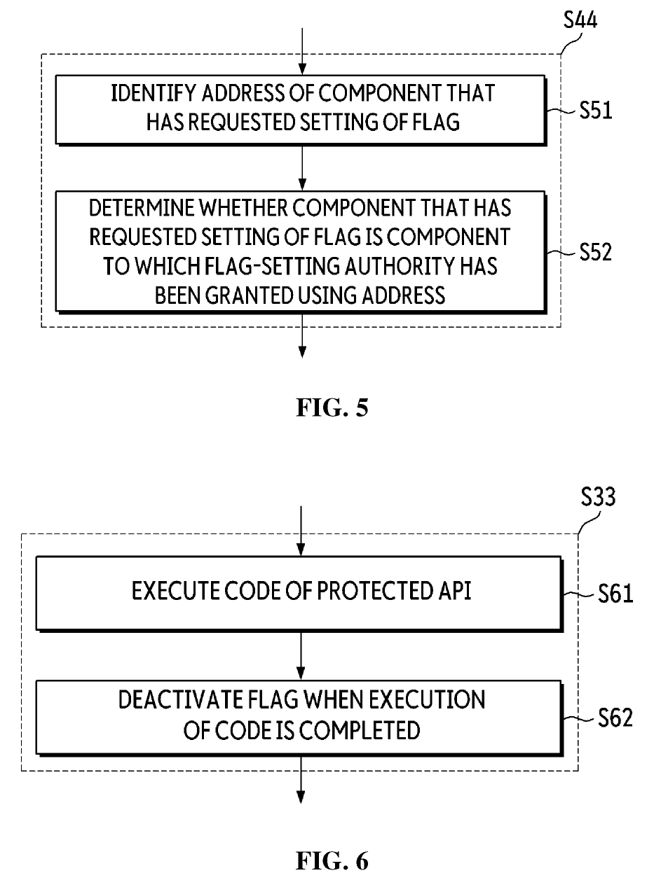

In an embodiment, even when the flag is set to the activated state, validity of the flag may be additionally verified in step S44. This is to prevent a component that does not have flag-setting authority from directly accessing the flag or arbitrarily modifying a value of the flag, and may include determining whether a subject that has requested setting of the flag has flag-setting authority. Hereinafter, with reference to FIG. 5, a flag validity determination operation performed in step S44 will be described in more detail.

FIG. 5 illustrates detailed operations of step S44 of FIG. 4.

Referring to FIG. 5, first, in step S51, an operation of identifying an address of a component that has requested setting of the flag indicating the authority state may be performed. The address of the component may be obtained, for example, through a program counter (PC) value, a link register (LR) value, or a stack frame.

Subsequently, in step S52, by using the identified address, an operation of determining whether the component that has requested setting of the flag is a component to which flag-setting authority has been granted may be performed. Here, the component to which flag-setting authority has been granted may include a protection function (e.g., protect()) implementing the protection mechanism or a function configuring a trusted protection path.

Referring again to FIG. 4, when the flag is determined to be valid (YES) as a result of the validity determination of the flag, the call may be determined to have been made by the component to which call authority has been granted (S45). Conversely, when the flag is determined to be invalid (NO), the call may be determined to have been made by a component to which call authority has not been granted (S43).

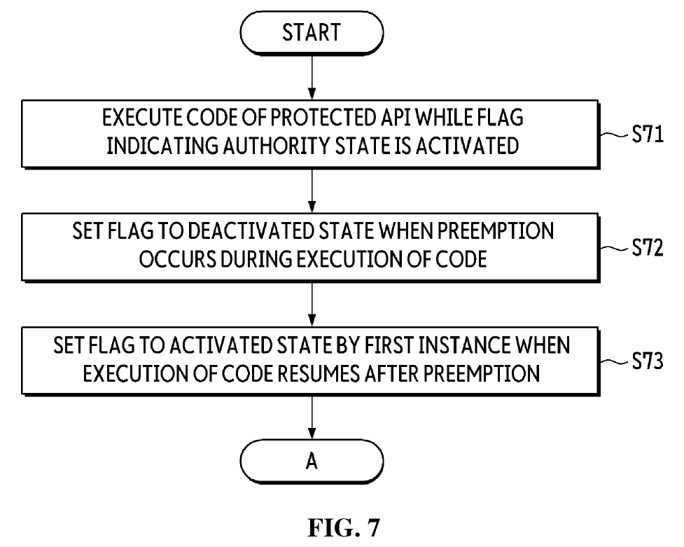

Referring again to FIG. 3, when the call is determined to have been made by the component to which call authority has been granted (YES), execution of the protected API may be allowed (S33). Hereinafter, with reference to FIG. 6, an operation performed in step S33 will be described in further detail.

FIG. 6 illustrates detailed operations of step S33 of FIG. 3.

Referring to FIG. 6, in step S61, an operation of executing code of the protected API may be performed. The code may include a set of instructions performing an operation requested by the caller and corresponds to functional code of the protected API that is allowed to be executed only when the call is determined to be a legal call.

Subsequently, in step S62, when execution of the code is completed, an operation of setting the flag indicating the authority state to the deactivated state may be performed. Deactivation of the flag initializes the authority state of the system so that authority verification is again performed for a subsequent call to the protected API. Through such an initialization procedure, the protection mechanism maintains the authority state only during a single call cycle and releases the authority state after completion of the call, thereby more effectively preventing unauthorized access to the protected API.

Referring again to FIG. 3, in step S34, when the call is determined to have been made by a component to which call authority has not been granted (NO), the call may be processed as an error. In an embodiment, when the call is processed as an error, an operation of generating an alert signal indicating that the call has been made by a component to which call authority has not been granted may be additionally performed. The alert signal may be implemented as, for example, a debugging log, a recorded system event, or a real-time warning message output to a developer interface. Such an alert signal may clearly convey a problematic point of the call to a developer or system administrator and may support early detection and correction of an improper call flow, thereby contributing to improvement of overall system security and reliability.

According to the above description, when a call to the protected API is detected, legality of the call may be determined before execution of the protected API based on whether the call has been made by a component to which call authority has been granted using a flag indicating an authority state. Execution of the protected API is allowed only when the call is determined to be a legal call. Conversely, when the call is determined to be an illegal call, execution of the protected API is disallowed, and the call is processed as an error, thereby effectively blocking improper calls.

Meanwhile, when execution of the protected API is allowed because the call is determined to be legal, preemption may occur in the system due to causes such as task switching or interrupt processing. In this case, there is a possibility that abnormal execution may occur because a component without authority calls or reenters the protected API while execution flow of the protected API is temporarily suspended.

Accordingly, in the present disclosure, a control operation may be performed such that unauthorized execution of the protected API does not occur even when preemption occurs. Hereinafter, such an operation will be described below in detail.

FIG. 7 is a flowchart illustrating an API call control method according to another embodiment of the present disclosure. However, this is merely a preferred embodiment for achieving the objectives of the present disclosure, and some steps may be added or omitted as necessary. In addition, an operating subject of each step may be a computing device, but for convenience of description, a description thereof may be omitted.

Referring to FIG. 7, first, in step S71, a first instance may execute code of a protected API while a flag indicating an authority state is in an activated state. At this time, execution of the code of the protected API may be performed only when a call to the protected API is determined to have been made by a component to which call authority has been granted.

That is, before step S71, an operation of detecting a call to the protected API and determining whether the call has been made by a component to which call authority has been granted may be made in advance. Only when the call is determined to have been made by a component to which call authority has been granted according to a result of the determination, code of the protected API is executed while the flag indicating the authority state is in the activated state. A detailed description thereof refers to the description in the previous embodiment.

Subsequently, in step S72, when preemption of a processor occurs by a second instance while the code is being executed, an operation of setting the flag to a deactivated state may be performed. Here, preemption means, for example, a situation in which system control is switched from a current first instance to a second instance corresponding to a second execution flow (or task) when the second execution flow has a higher priority than a first execution flow currently being executed.

Specifically, when preemption occurs, information of the first instance currently executing the code of the protected API may be stored, and the flag indicating the authority state may be set to the deactivated state. The stored information may include, for example, information on an execution environment such as a current state of the flag, an execution position of the first instance, or context. In this manner, when preemption occurs, by setting the flag to the deactivated state, unauthorized execution of the protected API by a component or execution flow without authority in the preempted state may be prevented.

Subsequently, in step S73, when execution of the code of the protected API is resumed after the preemption, the flag indicating the authority state may be set back to the activated state. Accordingly, execution of the code of the protected API may continue while maintaining a legal call state.

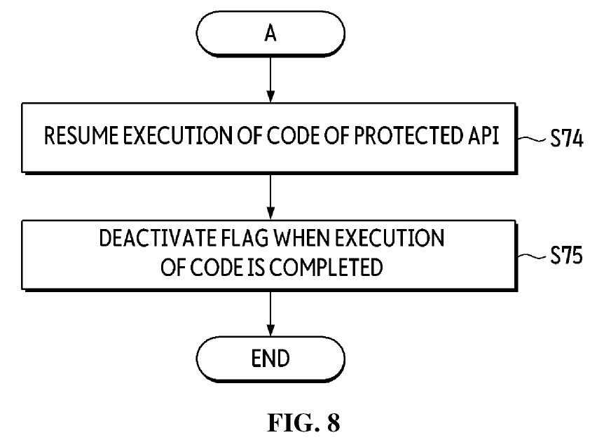

Hereinafter, with reference to FIG. 8, an operation following the operation of FIG. 7 will be described.

FIG. 8 illustrates an operation following the operation of FIG. 7.

Referring to FIG. 8, first, in step S74, execution of the code of the protected API may resume. At this time, by referring to state information of the first instance stored before occurrence of the preemption, execution of the code of the protected API may resume from the suspended point, thereby allowing the function of the protected API to consistently continue while maintaining the legal call state.

Subsequently, in step S75, when execution of the code of the protected API is completed normally, an operation of setting the flag indicating the authority state to the deactivated state may be performed. That is, the authority state temporarily granted in response to the call to the protected API disappears simultaneously with completion of execution of the protected API. Thus, for a subsequent call, the state of the system is restored such that a legality determination procedure may be performed again in a state in which the authority state is initialized. Such a configuration limits an authority grant state to a call unit, thereby providing an effect of preventing unauthorized execution in another execution flow or a reentry situation.

Thus far, with reference to FIGS. 3-8, the API call control methods according to some embodiments of the present disclosure have been described in detail. According to the above description, legality of a call to a protected API may be determined based on a flag indicating an authority state, and execution of the protected API may be blocked for an illegal call, thereby effectively preventing unauthorized access by a component or execution flow without authority. In addition, when preemption occurs during execution of the protected API, by temporarily setting the flag to a deactivated state and restoring the flag to an activated state when the execution flow returns, integrity of the authority state may be maintained, and unauthorized execution of the protected API may be more effectively prevented.

Furthermore, by setting the flag indicating the authority state to the deactivated state when execution of the protected API is completed normally, an authority grant state may be clearly limited to a call unit. According to such a configuration, after the call ends, the authority state is automatically released, thereby fundamentally blocking unauthorized execution that may occur due to another execution flow or abnormal re-calling.

Meanwhile, although description has been provided mainly in an AUTOSAR architecture environment, an environment in which the API call control methods according to some embodiments of the present disclosure are applied is not limited thereto. The present disclosure may be applied to overall systems having a layered structure designed such that an upper software layer is prohibited from directly calling internal resources or functions of a lower layer and access is allowed only through a predefined trusted path.

That is, the present disclosure may also be effectively applied to embedded software systems having clear role separation and interface rules between upper and lower layers, for example, industrial control systems, avionics systems, or Internet-of-Things (IoT) platforms.

Hereinafter, the above-described computing device will be described with reference to FIG. 9.

FIG. 9 is a hardware configuration diagram of a computing device according to some embodiments of the present disclosure. Referring to FIG. 9, a computing device 1000 may be implemented, for example, in a form including a microcontroller unit (MCU) applicable to a vehicle control system or an embedded system.

Referring to FIG. 9, the computing device 1000 may include at least one processor 1100, a bus 1600, a communication interface 1200, a memory 1400 configured to load a computer program executed by the processor 1100, and a storage 1300 storing the computer program 1500. However, only components relevant to embodiments of the present disclosure are illustrated in FIG. 9. Thus, one of ordinary skill in the art may understand that other general-purpose components may further be included in addition to the components illustrated in FIG. 9. That is, various components other than those illustrated in FIG. 9 may further be included in the computing device 1000. In addition, in some embodiments, the computing device 1000 may be configured in a form in which some of the components illustrated in FIG. 9 are omitted. Hereinafter, the components of the computing device 1000 will be described.

The processor 1100 may control overall operations of components of the computing device 1000. The processor 1100 may include at least one of a central processing unit (CPU), a micro processor unit (MPU), a micro controller unit (MCU), a graphics processing unit (GPU), or any type of processor well known in the art. In addition, the processor 1100 may perform operations for at least one application or program for executing operations or methods according to embodiments of the present disclosure. The computing device 1000 may include one or more processors.

The memory 1400 may store various data, instructions, and/or information. The memory 1400 may load the computer program 1500 from the storage 1300 to execute operations or methods according to embodiments of the present disclosure. The memory 1400 may be implemented as volatile memory such as random-access memory (RAM), but the present disclosure is not limited thereto.

The bus 1600 may provide a communication function between components of the computing device 1000. The bus 1600 may be implemented as various types of buses such as an address bus, a data bus, and a control bus.

The communication interface 1200 may provide a communication function for transmitting and receiving data between the computing device 1000 and an external device. For example, the communication interface 1200 may include communication schemes widely used in MCU-based systems such as controller area network (CAN), local interconnect network (LIN), serial peripheral interface (SPI), inter-integrated circuit (I2C), or universal asynchronous receiver transmitter (UART).

The storage 1300 may non-transitorily store one or more computer programs 1500. The storage 1300 may include nonvolatile memory such as read only memory (ROM), erasable programmable ROM (EPROM), electrically erasable programmable ROM (EEPROM), flash memory, a hard disk, a removable disk, or any type of computer-readable recording medium well known in the art.

When the computer program 1500 is loaded into the memory 1400, the computer program 1500 may include one or more instructions causing the processor 1100 to perform operations or methods according to various embodiments of the present disclosure. That is, by executing the loaded instructions, the processor 1100 may perform operations or methods according to various embodiments of the present disclosure.

In an example, the computer program 1500 may include instructions for performing an operation of detecting a call to a protected API, an operation of determining whether the call has been made by a component to which call authority has been granted by using a flag indicating an authority state, and an operation of disallowing execution of the protected API in response to determining the call to have been made by a component to which call authority has not been granted. The flag may be configured to be set only by a component to which flag-setting authority has been granted.

In another example, the computer program 1500 may include instructions for performing an operation in which a first instance executes code of the protected API while a flag indicating an authority state is activated, an operation of setting the flag to a deactivated state in response to preemption of the processor 1100 being caused by a second instance while the code is being executed, and an operation in which the first instance sets the flag to the activated state when execution of the code is resumed after the preemption.

In yet another example, the computer program 1500 may include instructions for performing at least some of steps, operations, or methods described above with reference to FIGS. 1-8.

Thus far, with reference to FIGS. 1-9, various embodiments of the present disclosure and effects according to the embodiments have been described. Effects according to the technical concept of the present disclosure are not limited to those described above, and other effects not mentioned above may be clearly understood by one of ordinary skill in the art from the above description.

In addition, even though multiple components have been described in the above embodiments as being combined together or operating in combination, the technical concept of the present disclosure is not necessarily limited to such embodiments. That is, within the scope of the technical concept of the present disclosure, all components may operate in combination by being selectively combined with one or more components.

Although operations are shown in a specific order in the drawings, it should not be understood that desired results may be obtained when the operations must be performed in the specific order or sequential order or when all of the operations must be performed. In certain situations, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

The protection scope of the present invention should be interpreted by the following claims, and all technical ideas within the equivalent range should be interpreted as being included in the scope of the technical ideas defined by the present disclosure.

What is claimed is:

1. An application programming interface (API) call control method performed by a computing device, comprising:
detecting a call to a protected API;
determining, using a flag indicating an authority state, whether the call has been made by an authorized component to which a call authority has been granted; and
in response to the determining the call to have been made by an unauthorized component to which the call authority has not been granted, disallowing execution of the protected API,
wherein the flag is configured to be set only by an authority component to which an authority of setting the flag has been granted.

2. The API call control method of claim 1, wherein the authorized component to which the call authority has been granted is configured to call the protected API through the authority component to which the authority of setting the flag has been granted.

3. The API call control method of claim 1, wherein determining whether the call has been made by the authorized component to which the call authority has been granted comprises: determining a state of the flag; and in response to determining that the flag is set to an activated state, determining that the call has been made by the authorized component to which the call authority has been granted, and in response to determining that the flag is set to a deactivated state, determining that the call has been made by the unauthorized component to which the call authority has not been granted.

4. The API call control method of claim 3, wherein the determining whether the call has been made by the authorized component to which the call authority has been granted further comprises: in response to the determining that the flag is set to the activated state, determining validity of the flag; and in response to determining the flag to be valid, determining that the call has been made by the authorized component to which the call authority has been granted; and in response to the determining the flag to be invalid, determining that the call has been made by the unauthorized component to which the call authority has not been granted.

5. The API call control method of claim 4, wherein the determining the validity of the flag comprises: identifying an address of a candidate component that has requested setting of the flag; and determining, by using the address, whether the candidate component that has requested setting of the flag has the authority of setting the flag.

6. The API call control method of claim 1, wherein the disallowing the execution of the protected API comprises processing the call as an error.

7. The API call control method of claim 6, wherein the processing the call as the error comprises generating an alert signal indicating that the call has been made by the unauthorized component to which the call authority has not been granted.

8. The API call control method of claim 1, further comprising:
in response to the determining the call to have been made by the authorized component to which the call authority has been granted, allowing the execution of the protected API,
wherein the allowing the execution of the protected API comprises: executing code of the protected API; and in response to the executing the code is completed, setting the flag to a deactivated state.

9. An application programming interface (API) call control method performed by a computing device, comprising:
executing, by a first instance executed by the computing device, code of a protected API while a flag indicating an authority state is in an activated state;
in response to preemption of a processor being caused by a second instance while the code is being executed, setting the flag to a deactivated state; and
after the preemption, when the executing of the code resumes, setting, by the first instance, the flag to the activated state.

10. The API call control method of claim 9, further comprising:
resuming the executing of the code of the protected API by the first instance; and
in response to the executing of the code being completed, setting the flag to the deactivated state.

11. The API call control method of claim 9, further comprising:
before the executing the code of the protected API, detecting a call to the protected API; and
determining, using the flag, whether the call has been made by an authorized component to which a call authority has been granted.

12. The API call control method of claim 11, wherein the determining whether the call has been made by the authorized component to which the call authority has been granted comprises: determining a state of the flag; and in response to determining that the flag is set to the activated state, determining that the call has been made by the authorized component to which call the authority has been granted; and in response to determining that the flag is set to the deactivated state, determining that the call has been made by an unauthorized component to which the call authority has not been granted.

13. The API call control method of claim 12, wherein determining that the call has been made by the authorized component to which the call authority has been granted comprises: in response to the determining that the flag is set to the activated state, determining validity of the flag; and in response to determining the flag to be valid, determining that the call has been made by the authorized component to which the call authority has been granted, and in response to determining the flag to be invalid, determining that the call has been made by the unauthorized component to which the call authority has not been granted.

14. The API call control method of claim 13, wherein the determining the validity of the flag comprises: identifying an address of a candidate component that has requested setting of the flag; and determining, by using the address, whether the candidate component has the authority of setting the flag.

15. A computing device comprising:
at least one processor;
a communication interface;
a memory configured to load a computer program executed by the at least one processor; and
a storage configured to store the computer program,
wherein:
the computer program includes instructions for performing operations of: detecting a call to a protected application programming interface (API); determining, using a flag indicating an authority state, whether the call has been made by an authorized component to which a call authority has been granted; and in response to determining the call to have been made by an unauthorized component to which the call authority has not been granted, disallowing execution of the protected API; and
the flag is configured to be set only by an authority component to which an authority of setting the flag has been granted.

16. The computing device of claim 15, wherein the operation of determining whether the call has been made by the authorized component to which the call authority has been granted comprises: determining a state of the flag; and in response to determining that the flag is set to an activated state, determining that the call has been made by the authorized component to which the call authority has been granted, and in response to determining that the flag is set to a deactivated state, determining that the call has been made by the unauthorized component to which the call authority has not been granted.

17. The computing device of claim 16, wherein the operation of determining whether the call has been made by the authorized component to which the call authority has been granted further comprises: in response to the determining that the flag is set to the activated state, determining validity of the flag; and in response to determining the flag to be valid, determining that the call has been made by the authorized component to which the call authority has been granted, and in response to determining the flag to be invalid, determining that the call has been made by the unauthorized component to which the call authority has not been granted.

18. The computing device of claim 17, wherein the determining the validity of the flag comprises: identifying an address of a candidate component that has requested setting of the flag; and determining, by using the address, whether the candidate component that has requested setting of the flag has the authority of setting the flag.

19. The computing device of claim 15, wherein the operation of disallowing the execution of the protected API comprises processing the call as an error.

20. The computing device of claim 15, wherein:
the computer program further includes instructions for performing an operation of allowing the execution of the protected API in response to the determining the call to have been made by the authorized component to which the call authority has been granted; and
the operation of the allowing the execution of the protected API comprises: executing code of the protected API; and in response to the executing of the code is completed, setting the flag to a deactivated state.
